(19) United States
(12) Patent Application Publication
(10) Pub. No.: US 2024/0201729 A1
(43) Pub. Date: Jun. 20, 2024

(54) EVENT LOGGING BASED ON GLOBAL CLOCK IN SYSTEM WITH MULTIPLE COMPONENTS

(71) Applicant: Cirrus Logic International Semiconductor Ltd., Edinburgh (GB)

(72) Inventors: Trenton Henry, Austin, TX (US); Nariankadu D. Hemkumar, Austin, TX (US)

(73) Assignee: Cirrus Logic International Semiconductor Ltd., Edinburgh (GB)

(21) Appl. No.: 18/067,307

(22) Filed: Dec. 16, 2022

(51) Int. Cl. G06F 1/12; G06F 1/14

(52) U.S. Cl. CPC G06F 1/12; G06F 1/14

(57) ABSTRACT

This disclosure relates to instrumenting of integrated circuits, and particularly with providing synchronized time stamps for logging data from multiple components. An example method includes injecting code in a read only memory (ROM) that performs the logging with time stamps. The method may include receiving, from a first component, data describing a first event with a first time stamp synchronized to a global clock; receiving, from a second component, data describing a second event with a second time stamp synchronized to the global clock; and generating a report comprising the first event and the second event, wherein the first event is synchronized with the second event. Other aspects are also disclosed.

### FIELD OF THE DISCLOSURE

The instant disclosure relates to instrumentation systems. More specifically, portions of this disclosure relate to debugging system operation involving multiple components by synchronizing event logging to a global clock.

### BACKGROUND

Instrumentation is a technique for program analysis tasks such as profiling, performance evaluation, and bottleneck analysis, as well as for software engineering tasks such as bug detection, and finding hot and dead logic. Due to runtime overhead, instrumentation may slow program execution, which may distort execution timing and cause concurrency malfunctions such as race conditions. For concurrent programs, an exact ordering of events may be preserved, which may further slow program execution but facilitates debugging race conditions or other dynamic conditions.

Instrumentation can be implemented at various stages, including statically at compiling or linking or dynamically at runtime. Static instrumentation may employ compilation tools to insert extra logic to instrument an application at compile or link time or employs a binary rewriter to modify the application after it is built. Dynamic instrumentation may insert extra logic into the application binary at runtime. Either method may impact the performance/operation of the monitored system due to the extra instructions inserted and executed along with the application itself.

Static instrumentation has the potential advantage of an optimized instrumented binary owing to the additional information available at compile/link time. However, this instrumentation may impact the normal mission mode operation of the application. Dynamic instrumentation has the advantage that the normal mission mode application is unaffected by instrumentation, as the instrumentation instructions are injected on demand at runtime. However, depending upon the instrumentation framework, this may be a substantial number of instructions and may risk exceeding the available RAM space and/or processing bandwidth (MIPs) of the system under analysis.

Shortcomings mentioned here are only representative and are included to highlight problems that the inventors have identified with respect to existing computer systems and sought to improve upon. Aspects of computer systems described below may address some or all of the shortcomings as well as others known in the art. Aspects of the improved information handling systems described below may present other benefits than, and be used in other applications than, those described above.

### SUMMARY

Any of the conventional instrumentation techniques have shortcomings with respect to logging for multiple components. In the example of an integrated circuit, different portions of the integrated circuit, referred to as first, second, third, or additional components, may operate from different clock signals. Although the components are coupled together and communicate with each other, the different components may be operating from clock signals with different frequencies or different offsets. Logging of events occurring in each of the components are thus unsynchronized. Multiple component interactions and timing are difficult to understand because the relationships between various contexts of execution may be unobservable. The timing differences between events in different components of an integrated circuit may occur in other systems as well. For example, in a computer system with multiple chips coupled to a printed circuit board or with multiple chips coupled to multiple printed circuit boards, different components may operate from different clock signals (even if each component's clock is generated from a common clock signal).

The unsynchronized logging between components makes certain fault conditions difficult to identify. For example, there should be no time during which one component (e.g., one processor core of an integrated circuit) holds a shared resource and another component (e.g., another processor core of the integrated circuit) is blocked from making progress because of a conflict for accessing that shared resource. Additional examples include ensuring that no computation exceeds a deadline, thus delaying subsequent computations, potentially skewing the timing of the entire system. To obtain data for ascertaining the behavior of the system, instrumentation according to embodiments of this disclosure instrument the system in a manner that event information from multiple components may be compared on a single global timeline. This instrumenting may include providing time stamps accompanying event information, in which the time stamps are synchronized with a global clock.

According to one embodiment, a method includes receiving, from a first component, data describing a first event with a first time stamp synchronized to a global clock; receiving, from a second component, data describing a second event with a second time stamp synchronized to the global clock; and generating a report comprising the first event and the second event, wherein the first event is synchronized with the second event.

In certain embodiments, the method may include modifying the first component to report the first event; and modifying the second component to report the second event. Modifying the first component may include injecting a code segment into a first software module of the first component configuring the first component to transmit the first event with the first time stamp. Injecting the code segment into the first software module may include replacing a pointer to a function in read only memory (ROM).

In certain embodiments, the first time stamp is based on a register value of the global clock and the register value is related to a clock cycle count of the global clock, and the second time stamp is based on the register value of the global clock.

The global clock synchronized instrumentation of two or more components may be used in a variety of hardware configurations. In some embodiments, the first component comprises a first processor of an integrated circuit and the second component comprises a second processor of the integrated circuit. In some embodiments, the first component comprises a first processor of a first integrated circuit and the second component comprises a second processor of a second integrated circuit on a separate semiconductor die from the first integrated circuit, wherein the first time stamp is synchronized with the second time stamp across the first integrated circuit and the second integrated circuit.

The instrumentation may allow analysis of system behavior of multiple components and how those components interact with or affect each other by allowing different component events to be placed on a common global clock-based timeline. In some embodiments, the method may include determining a behavioral pattern for the first component and the second component based on the report indicating a failure of the first component or the second component. In some embodiments, the method may include determining a decrease of performance for the first component or the second component based on the report indicating a failure of the first component or the second component.

An apparatus may be configured for performing the method described according to certain embodiments herein. For example, an apparatus may include a processor coupled to a memory, wherein the processor is configured to perform the steps of various embodiments of the methods described herein. The processor may be configured by executing computer program code comprising instructions that cause the processor to perform the various steps.

The method may be embedded in a computer-readable medium as computer program code comprising instructions that cause a processor to perform the steps of the method. In some embodiments, the processor may be part of an information handling system including a first network adaptor configured to transmit data over a first network connection of a plurality of network connections; and a processor coupled to the first network adaptor, and the memory. In some embodiments, the network connection may couple the information handling system to an external component, such as a wired or wireless docking station.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an example system for instrumentation using a global clock according to some embodiments of the disclosure.

FIG. 2 is a block diagram illustrating insertion of new codes during operation of a processor according to one or more embodiments of the disclosure.

FIG. 3 is a flow chart illustrating an example method for instrumenting a system with a global clock according to one or more embodiments of the disclosure.

FIG. 4 is a flow chart illustrating an example method for analyzing system behavior of an instrumented system with a global clock according to one or more embodiments of the disclosure.

### DETAILED DESCRIPTION

Instrumentation techniques for understanding system operation described herein may be used for preproduction vetting of electronic devices, post-fabrication validation of electronic devices, verification preproduction of electronic devices, and/or in situ testing (e.g., testing during operation of the electronic device). A global clock signal provided to the components being instrumented allows for understanding of cause-effect relationship between operations on different components. The instrumentation may be performed, in some embodiments, by injecting code during execution of existing code (e.g., ROM code). Injecting the code when instrumentation is desired provides the benefit of a reduced ROM code size because the ROM code does not itself include the instrumentation functions. The instrumented reports with global clock-synchronized events may be used to facilitate analysis of call tree duration and/or depth, interrupt periodicity, and other analysis.

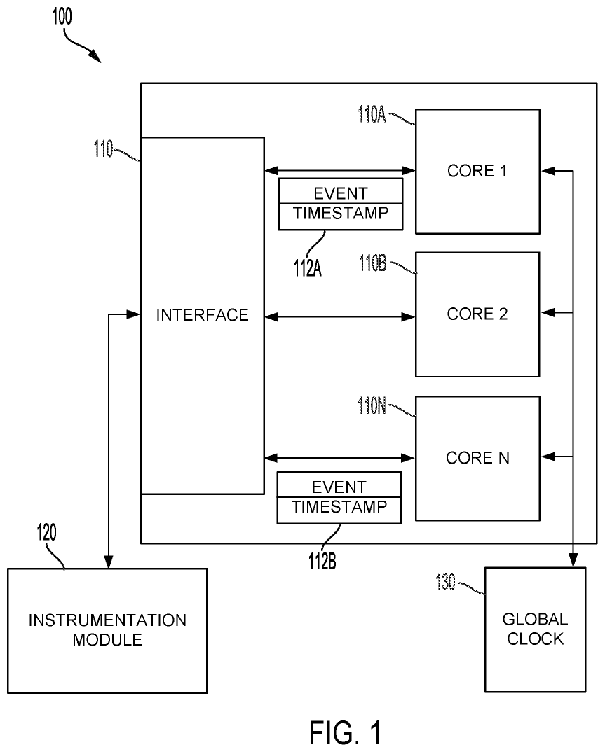

FIG. 1 is a block diagram illustrating an example system for instrumentation using a global clock according to some embodiments of the disclosure. A system 100 includes two or more components, such as cores 110A-N. The cores 110A-N may be different processing cores of a central processing unit (CPU). The cores 110A-N may alternatively be different signal processing engines or other circuitry. The cores 110A-N may have the same or similar configuration, such as when all cores 110A-N are processors. The cores 110A-N may have different configurations, such as when the cores 110A-N includes a combination of an audio processor, a video processor, a processor, and/or other components.

The cores 110A-N may be accessible by an instrumentation module 120 through an interface 110. For example, the cores 110A-N may be coupled by a bus within an integrated circuit or on a printed circuit board to the interface 110, which is coupled to the instrumentation module 120 through an internal bus or external bus. The bus coupling the interface 110 to the instrumentation module 120 may be, for example, an I2C bus, a peripheral component interface (PCI) bus, a universal serial bus (USB), serial peripheral interface (SPI), system power management interface (SPMI), secure digital input output (SDIO), or other serial or parallel bus. The instrumentation module 120 may be an external computing device, such as another computer system. The instrumentation module 120 may alternatively be a separate chip on a printed circuit board coupled to the cores 110A-N or a separate component in an integrated circuit with the cores 110A-N. In some embodiments, the instrumentation module 120 may be a personal computer (PC) coupled to the system under test via the interface 110. For example, the PC may read data sent over a universal asynchronous receiver-transmitter (UART) by the system under test. In another example, the PC may execute special purpose software to operate as a special purpose piece of hardware that reads data from the system under test, such as a PC running a debugger using a debug pod to retrieve data via a debug interface.

The cores 110A-N may provide information for instrumentation of the system 100 through the interface 110 to the instrumentation module 120. The information may include a report of an event with an associated timestamp indicating timing information for the event. Core 110A may generate a report 112A including event information (e.g., an indicator of a condition encountered by the core 110A) and a timestamp. Core 110N may generate a report 112B including event information (e.g., an indicator of a condition encountered by the core 110A) and a timestamp. The timestamps in report 112A-B may be based on a same global clock 130 provided to the cores 110A-N. The reports 112A-B, which are based on the same clock, may be used, for example, to diagnose resource sharing conflicts that stall operations on the cores 110A-N. Instrumentation module 120 may be able to diagnose an error in core 110A indicated by a report 112A that indicates core 110A stalled due to access to a shared resource based on information in report 112B that core 110N was accessing the shared resource at the time of the event in the report 112A. In some embodiments, the system 100 may be simulated in a field programmable gate array (FPGA) to verify software executed by the cores 110A-N, such as read-only memory (ROM) code for the system 100.

The global clock 130 may be provided in a synchronized manner to each of the cores 110A-N according to several different techniques. In some embodiments, the global clock 130 may be provided by locking phase of a clock signal at each of the cores 110A-N. For example, a single clock signal may be generated and provided to each of the cores 110A-N. Although there may be an offset of the clock signal between different components, the phase of the clock signal may be locked at each of the cores 110A-N such that each of the cores 110A-N may report event information with synchronized information. In these embodiments, the locked phase may reduce or eliminate further synchronization between the cores 110A-N and the global clock 130. In some embodiments, the global clock 130 may be provided as a hardware clock with registers. When one of the cores 110A-N generates a report, the core may read the global clock register for a current value. That current value may be included in the report as the timestamp. The first time stamp may be based on a register value of the global clock and the register value is related to a clock cycle count of the global clock. Likewise, the second time stamp is based on the register value of the global clock.

In one embodiment of a multi-core processor, local timekeepers on each processor instance may start automatically when the processor instance comes out of reset. The controlling processor instance's controlling core enables a managed/secondary processor instance to execute. The secondary processor instance's controlling core starts executing with a local timekeeper. The controlling processor instance reads the controlling processor's local timekeeper and emits an event representing the starting of the secondary processing instance. Post-processing software interprets the instrumentation data and uses this event's timestamp as the time delta between the processing instances and adjusts information accordingly.

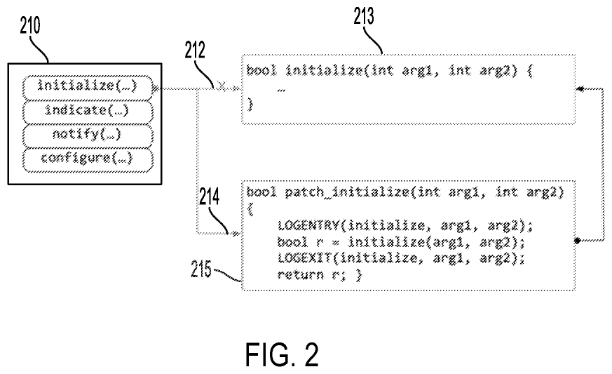

A flexible and customizable framework for instrumentation in FIG. 1 may provide for profiling that may span single to multiple cores or components across single to multiple integrated circuits. In some embodiments, patching mechanisms built into the ROM firmware may be used to limit intrusiveness to focal areas of interactions (hardware to software and/or software to software). An example of a patching mechanism in the instrumentation of system 100 is described with reference to FIG. 2.

FIG. 2 is a block diagram illustrating insertion of new codes during operation of a processor according to one or more embodiments of the disclosure. A system may execute code 210. During normal operation, when no instrumentation is performed, the system may follow function calls in the code 213, such as call 212 for initializing the system. When instrumentation is performed, the system may follow function call 214 to code 215 for initializing the system and generating one or more reports during initialization. The redirection of execution of code 210 from call 212 to call 214 may be a result of modifying the cores or components, in which the redirection causes the generation of report 112A-B. In some embodiments, the redirection may be accomplished by injecting a code segment into a first software module of the first component configuring the first component to transmit the first event with the first time stamp. Likewise, the same or a different code segment may be injected into a second software module of the second component configuring the second component to transmit the second event with the second time stamp. The switch from call 212 to call 214 may include replacing a pointer to a function in read only memory (ROM). For example, the function pointed to for execution may be in ROM, the pointer to that function for execution by the system under test may be in RAM, and the replacement function may be in RAM. The pointer in RAM may be changed such that the pointer no longer points to the original function in or from the ROM but instead points to the replacement function in RAM.

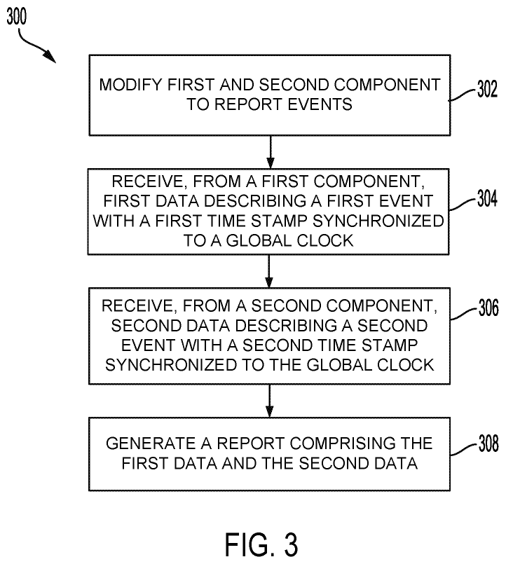

FIG. 3 is a flow chart illustrating an example method for instrumenting a system with a global clock according to one or more embodiments of the disclosure. A method 300 includes, at block 302, modifying first and second components to report events. Block 302 may include activating a test mode of a system including the first and second components. In some embodiments, the modification of block 302 may include injection of code for instrumentation during execution of the system under test. At block 304, the instrumentation module receives, from a first component, first data describing a first event with a first time stamp synchronized to a global clock. At block 306, the instrumentation module receives, from a second component, second data describing a second event with a second time stamp synchronized to the global clock. At block 308, the instrumentation module may generate a report comprising the first data and the second data organized according to a global clock timeline. Placing the first event, the second event, and additional events received from the system under test on a common timeline according to the global clock allows improved analysis of the behavior and/or errors of the system under test.

The first and second components may be first and second processors of an integrated circuit, such as two cores on a shared substrate. The first and second components may be first and second processors of a respective first and second integrated circuit, the integrated circuits on separate semiconductor dies. The global clock may be synchronized across circuits on the same or different integrated circuits.

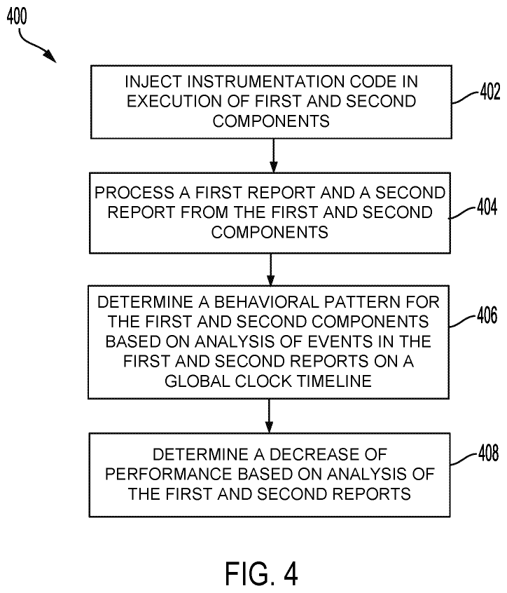

The common global clock-synchronized timeline may allow for improved analysis of system operation. One example instrumentation analysis is described with reference to FIG. 4. FIG. 4 is a flow chart illustrating an example method for analyzing system behavior of an instrumented system with a global clock according to one or more embodiments of the disclosure. At block 402, the instrumentation module injects instrumentation code during execution of first and second components. At block 404, first and second reports are received from first and second components, and the reports are processed. At block 406, a behavioral pattern may be determined for the first and second components based on analysis of events in the first and second reports on a global clock timeline. In some embodiments, determining a behavioral pattern for the first component and the second component may be based on the report indicating a failure of the first component or the second component. The behavioral pattern may provide more information than merely an indication of a failure, but may also provide information that, for example, the system under test is operating correctly or that certain event periodicity is within an expected range. At block 408, analysis of the behavioral pattern may allow determining a decrease of performance for the first component or the second component, upon which the instrumentation module may adjust settings within the system under test and/or a system designer may implement adjustments to the system under test.

The schematic flow chart diagrams of FIG. 3 or 4 is generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The operations described above as performed by a system in test, which may include a controller, may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving, from a first component, data describing a first event with a first time stamp synchronized to a global clock;
receiving, from a second component, data describing a second event with a second time stamp synchronized to the global clock; and
generating a report comprising the first event and the second event, wherein the first event is synchronized with the second event.

2. The method of claim 1, further comprising:
modifying the first component to report the first event; and
modifying the second component to report the second event.

3. The method of claim 2, wherein modifying the first component comprises injecting a code segment into a first software module of the first component configuring the first component to transmit the first event with the first time stamp.

4. The method of claim 3, wherein injecting the code segment into the first software module comprises replacing a pointer to a function in read only memory (ROM).

5. The method of claim 1, wherein:
the first time stamp is based on a register value of the global clock and the register value is related to a clock cycle count of the global clock, and
the second time stamp is based on the register value of the global clock.

6. The method of claim 1, wherein the first component comprises a first processor of an integrated circuit and the second component comprises a second processor of the integrated circuit.

7. The method of claim 1, wherein the first component comprises a first processor of a first integrated circuit and the second component comprises a second processor of a second integrated circuit on a separate semiconductor die from the first integrated circuit, wherein the first time stamp is synchronized with the second time stamp across the first integrated circuit and the second integrated circuit.

8. The method of claim 1, further comprising determining a behavioral pattern for the first component and the second component based on the report indicating a failure of the first component or the second component.

9. The method of claim 1, further comprising determining a decrease of performance for the first component or the second component based on the report indicating a failure of the first component or the second component.

10. An electronic device, comprising:
an instrumentation module configured to communicate with a first electronic component and to a second electronic component, wherein the instrumentation module is configured to perform operations comprising:
receiving, from the first electronic component, data describing a first event with a first time stamp synchronized to a global clock;
receiving, from the second electronic component, data describing a second event with a second time stamp synchronized to the global clock; and
generating a report comprising the first event and the second event, wherein the first event is synchronized with the second event.

11. The electronic device of claim 10, wherein the instrumentation module is further configured to perform operations comprising:
modifying the first electronic component to report the first event; and
modifying the second electronic component to report the second event.

12. The electronic device of claim 11, wherein modifying the first electronic component comprises injecting a code segment into a first software module of the first electronic component configuring the first electronic component to transmit the first event with the first time stamp.

13. The electronic device of claim 12, wherein injecting the code segment into the first software module comprises replacing a pointer to a function in read only memory (ROM).

14. The electronic device of claim 11, wherein:
the first time stamp is based on a register value of the global clock and the register value is related to a clock cycle count of the global clock, and
the second time stamp is based on the register value of the global clock.

15. The electronic device of claim 11, wherein the instrumentation module is further configured to perform operations comprising:
determining a behavioral pattern for the first electronic component and the second electronic component based on the report indicating a failure of the first electronic component or the second electronic component.

16. An apparatus, comprising:
a first processor;
a second processor;
a memory coupled to the first processor and the second processor; and
an instrumentation module coupled to the first processor and to the second processor, wherein the instrumentation module is configured to perform operations comprising:
receiving, from the first processor, data describing a first event with a first time stamp synchronized to a global clock;
receiving, from the second processor, data describing a second event with a second time stamp synchronized to the global clock; and
generating a report comprising the first event and the second event, wherein the first event is synchronized with the second event.

17. The apparatus of claim 16, wherein the first processor and the second processor are on a single semiconductor die.

18. The apparatus of claim 17, wherein:
modifying the first processor comprises injecting a first code segment into a first software module in the memory executed by the first processor configuring the first processor to transmit the first event with the first time stamp, and
modifying the second processor comprises injecting a second code segment into a second software module in the memory executed by the second processor configuring the second processor to transmit the second event with the second time stamp.

19. The apparatus of claim 18, wherein:
injecting the first code segment into the first software module comprises replacing a pointer to a function in read only memory (ROM) in the first software module with a first address to the first code segment,
injecting the second code segment into the second software module comprises replacing a pointer to a function in read only memory (ROM) in the second software module with a second address to the second code segment.

20. The apparatus of claim 19, wherein the instrumentation module is configured to perform operations comprising:
determining a behavioral pattern for the first processor and the second processor based on the report indicating a failure of the first processor or the second processor.
